(19) United States
(12) Patent Application Publication
(10) Pub. No.: US 2011/0069260 A1
(43) Pub. Date: Mar. 24, 2011

(54) Display panel and repair method thereof

(75) Inventors: He-Yuan Yang, Hsinchu City (TW); Che-Hsiu Yang, Taichung City (TW); You-Ming Nian, Taipei City (TW); Ching-Yao Chen, Taichung City (TW); Tsung-Yu Wu, Yunlin County (TW)

(73) Assignee: Au Optronics Corporation, Hsinchu (TW)

(21) Appl. No.: 12/590,777

(22) Filed: Nov. 13, 2009

(30) Foreign Application Priority Data
Sep. 18, 2009 (TW) 98131585

(51) Int. Cl. G02F 1/1333; H01J 9/50

(52) U.S. Cl. 349/110; 445/2

(57) ABSTRACT

A method for repairing a display panel having a defect is provided, wherein a polarizer has been attached to a surface of the display panel, and the method includes following steps. First, a recess corresponding to the defect is formed at an outer surface of the polarizer. Afterward, a light-shielding material is filled into the recess. Besides, a display panel with a good display quality is also provided.

### CROSS-REFERENCE TO RELATED APPLICATION

This application claims the priority benefit of Taiwan application serial no. 98131585, filed Sep. 18, 2009. The entirety of the above-mentioned patent application is hereby incorporated by reference herein and made a part of specification.

### BACKGROUND OF THE DISCLOSURE

1. Technical Field

The present disclosure relates to a display panel and a repair method thereof. More particularly, the present disclosure relates to a display panel having a good display quality and a good production yield, which is easy to be rework, and a repair method thereof.

2. Description of Related Art

Generally, a display panel is mainly formed by an active device array substrate, an opposite substrate and a display medium, and a polarizer is further disposed on an outside surface of the display panel. During a fabrication process of the display panel, especially a fabrication process of the active device, unexpected particles are probably remained on or sink into the active device due to unsatisfactory control of a clean room, equipments and fabrication conditions. These particles can cause abnormal short circuit or open circuit (which is determined according to an actual design), so that pixels corresponding to defects can form bright points, and such problem is conventionally referred to as a bright point defect.

To resolve the above problem, a U.S. Patent No. 2007/0035678 provides a method for repairing the display panel. First, the polarizer and the display panel are separated to expose the outside surface of the active device array substrate, wherein the active device array substrate has a glass substrate and an active device array layer is disposed on the inner surface of the glass substrate. Next, a mechanical drilling is performed to a glass substrate of the active device array substrate, so as to form a hole corresponding to the bright point defect. Next, a light-shielding material is filled in the hole. Next, the polarizer is attached to the outside of the glass substrate of the active device array substrate. According to such method, the bright point defect of the display panel can be darkened, so that a user cannot perceive an abnormity of the bright point defect.

However, according to the above method for repairing the display panel, the polarizer and the display panel have to be separated and re-attached, so that repair of the display panel is very time-consuming and difficult, i.e. rework thereof is not easy. On the other hand, since the mechanical drilling can crack the fragile glass substrate or cause a stress concentration, the display panel is liable to be damaged during a follow-up processing and cannot be repaired. In other words, the conventional method for repairing the display panel influences a production yield.

### SUMMARY OF THE DISCLOSURE

The present disclosure is directed to a method for repairing a display panel, which can repair a bright point defect through simple steps, and has a high rework efficiency.

The present disclosure is directed to a display panel, which has a good production yield and a good display quality.

The present disclosure provides a method for repairing a display panel, which is adapted to the display panel having a defect, wherein a surface of the display panel is attached with a polarizer, and the method includes following steps. First, a recess corresponding to the defect is formed at an outer surface of the polarizer. Afterward, a light-shielding material is filled into the recess.

In an embodiment of the present disclosure, a method of forming the recess at the outer surface of the polarizer includes laser treatment.

In an embodiment of the present disclosure, the laser treatment comprises applying an Nd-YAG laser to form the recess at the outer surface of the polarizer.

In an embodiment of the present disclosure, a peak wavelength of the Nd-YAG laser is about 266 nanometers (nm), about 355 nm, about 213 nm, or about 193 nm.

In an embodiment of the present disclosure, energy of the Nd-YAG laser is between 0.1 mJ and 2.0 mJ.

In an embodiment of the present disclosure, a method of forming the light-shielding material includes following steps. First, a light-shielding ink is filled in the recess. Next, the light-shielding ink is cured.

In an embodiment of the present disclosure, a material of the light-shielding ink includes epoxy resin, acrylic resin or styrene-butadiene rubber (SBR).

In an embodiment of the present disclosure, the light-shielding ink includes a thermal curing material.

In an embodiment of the present disclosure, a curing temperature of the thermal curing material is between about 50 degrees centigrade and about 70 degrees centigrade.

In an embodiment of the present disclosure, the light-shielding ink includes an ultraviolet (UV) curing material.

In an embodiment of the present disclosure, the UV curing material is cured by UV light, and a wavelength range of the UV light is between about 200 nm and about 400 nm.

In an embodiment of the preset disclosure, the light-shielding ink includes an infrared curing material.

In an embodiment of the present disclosure, the infrared curing material is cured by infrared, and a wavelength range of the infrared is between about 2.6 μm and about 25 μm.

The present disclosure provides a display panel including a display medium cell, a polarizer and a light-shielding material. The display medium cell has a defect. The polarizer is disposed on a surface of the display medium cell, wherein an outer surface of the polarizer has a recess corresponding to the defect. The light-shielding material is disposed in the recess.

According to the above descriptions, in the method for repairing the display panel of the present disclosure, the polarizer and the display panel are unnecessary to be separated, so that the method can be implemented by simple steps and has a high rework efficiency. Moreover, in the display panel of the present disclosure, since the light-shielding material is formed on the polarizer to repair the defect, and the repairing can be performed without damaging the display panel, the display panel may have a good display quality and a good production yield.

In order to make the aforementioned and other features and advantages of the present disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a cross-sectional view of a display panel according to an embodiment of the present disclosure, wherein a bright point defect of the display panel has been repaired.

FIGS. 2A-2C are schematic diagrams illustrating a process for repairing a display panel according to an embodiment of the present disclosure.

FIG. 3 is an amplified diagram illustrating a region encircled by dot lines of FIG. 2B.

FIG. 4 is a partial top view of a display panel after a laser treatment is performed according to an embodiment of the present disclosure.

### DESCRIPTION OF THE EMBODIMENTS

The present disclosure provides a method for repairing a display panel having a defect. Embodiments are provided below for describing the present disclosure in detail.

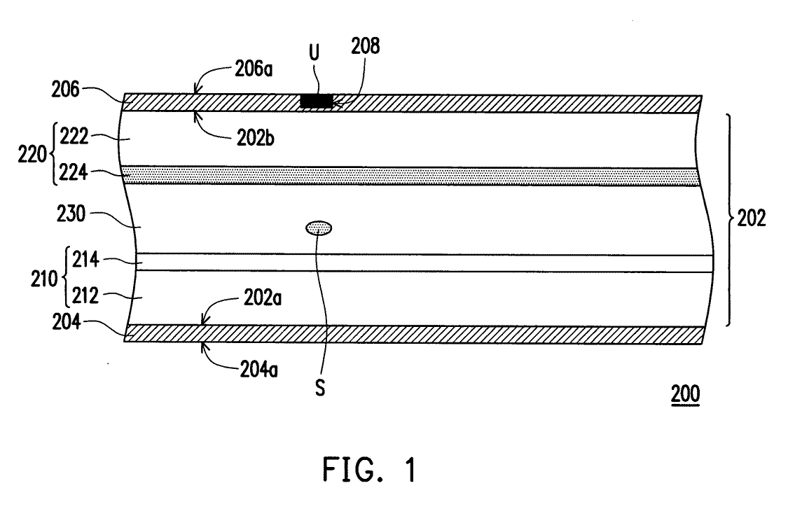

FIG. 1 is a cross-sectional view of a display panel according to an embodiment of the present disclosure, wherein a bright point defect of the display panel has been repaired. Referring to FIG. 1, the display panel 200 includes a display medium cell 202, polarizers 204 and 206, and a light-shielding material 208. The display medium cell 202 has a defect S. The polarizers 204 and 206 are respectively disposed on surfaces 202a and 202b of the display medium cell 202. In the present embodiment, a situation that an outer surface 206a of the polarizer 206 has a recess U corresponding to the defect S is taken as an example. The light-shielding material 208 is disposed in the recess U.

The display panel 200 is, for example, a liquid crystal display (LCD) panel, wherein the display medium cell 202 includes an active device array substrate 210, an opposite substrate 220 and a liquid crystal layer 230. The active device array substrate 210 is disposed opposite to the opposite substrate 220, and the liquid crystal layer 230 is located between the active device array substrate 210 and the opposite substrate 220. The active device array substrate 210 includes a substrate 212 (which is a transparent substrate, such as a glass substrate, a plastic substrate, etc., or other suitable substrates), and an active layer 214, wherein the active layer 214 is disposed on an inner surface of the glass substrate 212. The opposite substrate 220 includes a substrate 222 (which is a transparent substrate, such as a glass substrate, a plastic substrate, etc., or other suitable substrates), and a color filter layer 224, wherein the color filter layer 224 is disposed on an inner surface of the glass substrate 222, and is located opposite to the active layer 214. In other applicable embodiments of the present disclosure, the display panel 200 can also be an electrophoretic display panel, electroweting display panel, or other display panels. Namely, the display medium of the display medium cell 202 is not limited to the liquid crystal.

In the present embodiment, the defect S is, for example, located in the liquid crystal layer 230, and the defect S is a bright point defect, though the present disclosure is not limited thereto, and the defect S can also be located at any position in any of the film layer structures (for example, a dielectric layer, a conductive layer, a semiconductor layer, an alignment film layer, or a color filter layer) in the display medium cell 202. The light-shielding material 208 can shield light, so that when the display panel 200 displays an image, a position wherein the defect S is located forms a dark point, and a user cannot perceive the bright point defect. In other words, the repaired display panel 200 may have a good display quality.

It should be noticed that since the light-shielding material 208 is disposed in the recess U of the polarizer 206, even if the outer surface 206a of the polarizer 206 is wiped by organic solvent, the light-shielding material 208 is not easy to fall off. Moreover, the recess U is not limited to be disposed on the outer surface 206a of the polarizer 206, and in the other embodiments, the recess U can also be disposed on the outer surface 204a of the polarizer 204, or both of the outer surface 206a of the polarizer 206 and the outer surface 204a of the polarizer 204 have the recess U corresponding to the defect S. A position and a size of the recess U can be adjusted according to a position and a size of the defect S, so as to reduce an influence of the bright point defect. The recess U can be a square recess, a cone-shaped recess, a semicircular recess, an irregular recess, or recesses of other suitable shapes that can be fabricated by a laser source. Moreover, it should be noticed that a part of the polarizer 206 is still remained at a bottom of the recess U of FIG. 1, though the present disclosure is not limited thereto. In the other embodiments, the recess U can expose a part of the surface 202b of the substrate 222 and/or a part of the surface 202a of the substrate 212, though the substrates 212 and 222 do not have any manual-processing recess. Namely, during a process of forming the recess U, the outside surface of the substrates 212 and 222 are not damaged by a tool used for forming the recess U.

The method for repairing the display panel 200 is described in detail below.

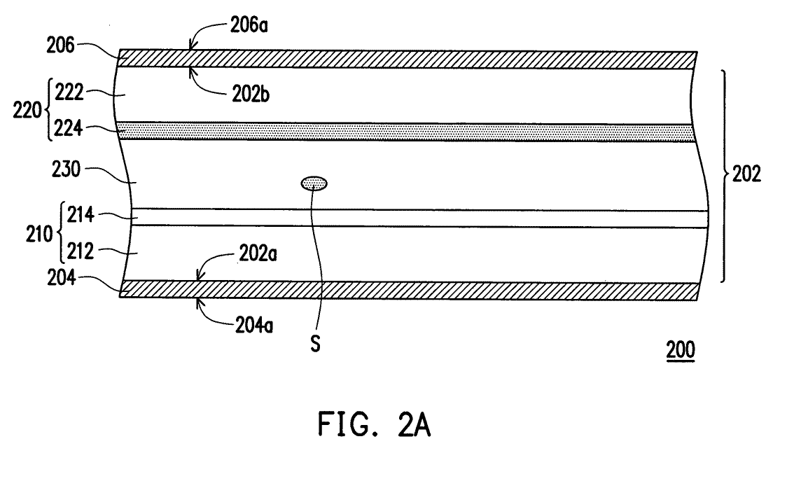

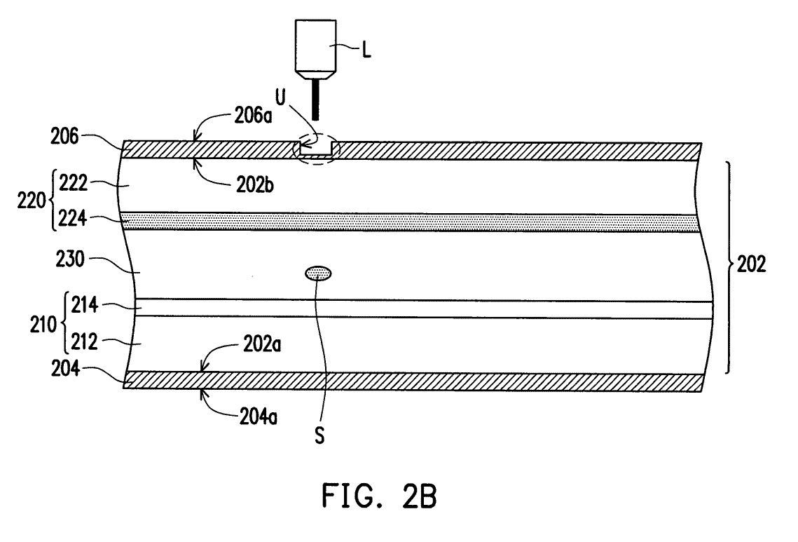

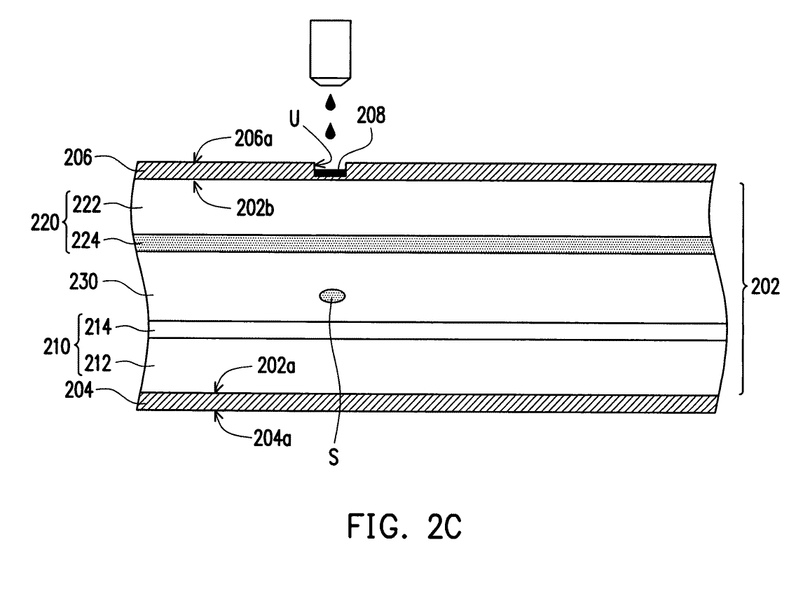

FIGS. 2A-2C are schematic diagrams illustrating a process for repairing a display panel according to an embodiment of the present disclosure. First, referring to FIG. 2A, the display panel 200 having the defect S is provided, wherein the bright point defect of the display panel 200 is still not repaired.

Next, referring to FIG. 2B, the recess U corresponding to the defect S is formed at the outer surface 206a of the polarize 206. In the present embodiment, the recess U is, for example, formed through a laser treatment L. In detail, the laser treatment L includes applying an Nd-YAG laser to form the recess at the outer surface of the polarizer, and a peak wavelength of the Nd-YAG laser is about 266 nm, about 355 nm, about 213 nm, or about 193 nm. Moreover, energy of the Nd-YAG laser is approximately between about 0.1 mJ and about 2.0 mJ.

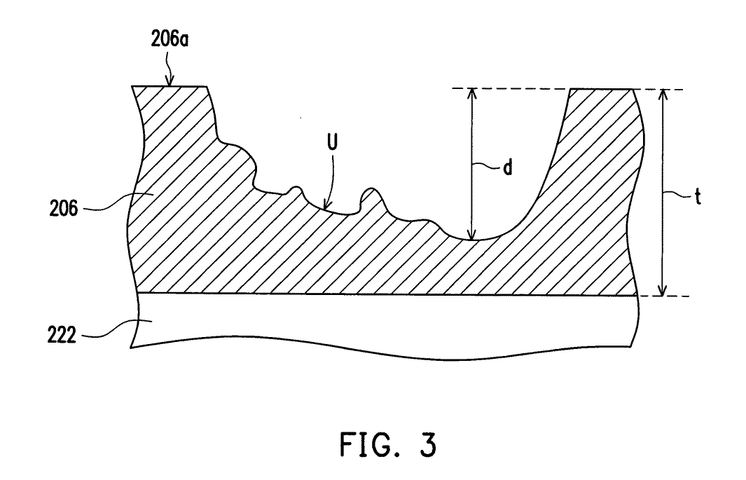

FIG. 3 is an amplified diagram illustrating a region encircled by dot lines of FIG. 2B. Referring to FIG. 2B and FIG. 3, in the present embedment, the Nd-YAG laser with the peak wavelength about 266 nm, the energy about 0.5 mJ, and a frequency about 20 Hz can be used, and about 150 times of the laser treatment L is performed to the outer surface 206a of the polarizer 206. As a result, the recess U with a depth d about 60-62 μm is formed on the outer surface 206a of the polarizer 206, though the present disclosure is not limited thereto, and in the other embodiments, the depth d can be changed according to a design requirement.

In the present embodiment, the depth d of the recess U is substantially less than a thickness t of the polarizer 206, i.e. the recess U does not penetrate through the polarizer 206. However, in another embodiment that is not illustrated, the recess U can also penetrate through the polarizer 206, i.e. the depth d of the recess U is equal to the thickness t of the polarizer 206. Particularly, since the peak wavelength of the laser used for the laser treatment L is determined according to a material of the polarizer 206, the laser treatment L is not liable to damage the substrate 222 (for example, a glass substrate) under the polarizer 206. Compared to a mechanical drilling of a conventional method, the laser treatment L can accurately control the depth d and a range of the recess U. Therefore, not only the defect 208 of the display panel 200 can be accurately repaired, but also damage of the display panel 200 during the repairing can be avoided.

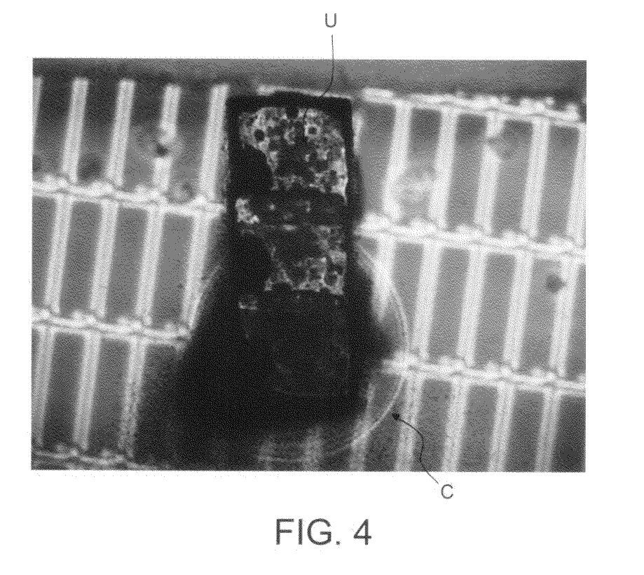

FIG. 4 is a partial top view of a display panel after the laser treatment is performed according to an embodiment of the present disclosure. Referring to FIG. 4, it should be noticed that if the peak wavelength of the laser used for the laser treatment L is inappropriate, the laser treatment L can cause a halo damage C (i.e. a circular grain in FIG. 4) on the outside surface of the polarizer. In some embodiments, an ultraviolet (UV) laser with a peak wavelength about 266 nm or about 355 nm can be used for the laser treatment L, so as to avoid the halo damage C. Moreover, if a visible laser with a wavelength greater than about 532 nm is used for the laser treatment L, a part of the laser can probably penetrate through the polarizer 206, so that an efficiency of forming the recess U is reduced. Even, the laser penetrated through the polarizer 206 can damage the color filter layer 224, or cause the liquid crystal layer 230 to generate bubbles. In brief, the laser with a suitable wavelength range can be selected to perform the laser treatment L, so as to avoid occurrence of the above problems.

Referring to FIG. 2C again, the light-shielding material 208 is filled in the recess U. In the present embodiment, a method of forming the light-shielding material 208 is to, for example, first fill a light-shielding ink in the recess U, and then cure the light-shielding ink. In such method, the light shielding material 208 can be filled in a part of the recess U, or can be fully filled in the recess U. Moreover, a material of the light-shielding ink can be epoxy resin, acrylic resin, styrene-butadiene rubber (SBR), or other suitable materials.

In another embodiment, the light-shielding ink can be a thermal curing material, such as phenolic resin, epoxide, unsaturated polyester, or other materials. Specifically, the phenolic resin is, for example, phenol formaldehyde, urea phenol formaldehyde, dicyandiamide (DCD) phenolic resin, ether link containing phenolic resin, phosphorus-containing phenolic resin, nylon modified phenolic resin, boron-containing phenolic resin, or other suitable materials or combinations thereof. Here, a curing temperature of the thermal curing material is, for example, between about 50 degrees centigrade and about 70 degrees centigrade. When the light-shielding ink is treated within such curing temperature range, a curing rate that the light-shielding ink is cured to form the light-shielding material 208 is optimal. However, if the curing temperature is beyond such range, the other components on the display panel 200 (such as active devices or non-active devices, or the polarizers, etc.) can be damaged.

In the other embodiments, the light-shielding ink can also be a UV curing material or an infrared curing material. The UV curing material is, for example, epoxy acrylate, polyurethane acrylate (PUA), poly acrylate, unsaturated polyester (UPE), polyether acrylate, or other suitable materials or combinations thereof. Wherein, the UV curing material is cured by UV light, and a wavelength range of the UV light is substantially between about 200 nm to about 400 nm. Preferably, a peak wavelength of the UV light is about 365 nm or about 254 nm. Moreover, the infrared curing material is, for example, propylene series, polyurethane, or other suitable materials or combinations thereof. The infrared curing material is cured by infrared, and a wavelength range of the infrared is substantially between 2.6-25 μm.

In the present embodiment, the light-shielding material 208 is, for example, disposed in the recess U on the polarizer 206, so as to achieve an effect of repairing the bright point defect. In the other embodiments, the light-shielding material 208 is disposed in the recess U on the polarizer 204, or the light-shielding material 208 is simultaneously disposed in the recess U on the polarizer 204 and the recess U on the polarizer 206. Compared to the conventional technique that the mechanical drilling is performed to drill the glass substrate, the display panel 200 of the present disclosure is not liable to be damaged. Therefore, the display panel 200 can simultaneously have a good display quality and a good production yield.

In summary, according to the method for repairing the display panel of the present disclosure, the recess is directly formed on the polarizer, and the light-shielding material is filled in the recess to repair the bright point defect. Therefore, the method of the present disclosure can be implemented by simple steps and has a high rework efficiency, and the light-shielding material is not easy to fall off. Moreover, in the display panel of the present disclosure, repairing of the defect is performed on the polarizer without damaging the other components, so that the display quality and the production yield of the display panel can be improved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for repairing a display panel, adapted to the display panel having a defect, wherein a surface of the display panel is attached with a polarizer, the method for repairing the display panel comprising:
forming a recess corresponding to the defect at an outer surface of the polarizer; and
filling a light-shielding material into the recess.

2. The method for repairing the display panel of claim 1, wherein a method of forming the recess at the outer surface of the polarizer comprises laser treatment.

3. The method for repairing the display panel of claim 2, wherein the laser treatment comprises applying an Nd-YAG laser to form the recess at the outer surface of the polarizer.

4. The method for repairing the display panel of claim 3, wherein a peak wavelength of the Nd-YAG laser is about 266 nanometers (nm), about 355 nm, about 213 nm, or about 193 nm.

5. The method for repairing the display panel of claim 3, wherein energy of the Nd-YAG laser is between about 0.1 mJ and about 2.0 mJ.

6. The method for repairing the display panel of claim 1, wherein a method of forming the light-shielding material comprises:
filling a light-shielding ink in the recess; and
curing the light-shielding ink.

7. The method for repairing the display panel of claim 6, wherein a material of the light-shielding ink comprises epoxy resin, acrylic resin, or styrene-butadiene rubber (SBR).

8. The method for repairing the display panel of claim 6, wherein the light-shielding ink comprises a thermal curing material.

9. The method for repairing the display panel of claim 8, wherein a curing temperature of the thermal curing material is between about 50 degrees centigrade and about 70 degrees centigrade.

10. The method for repairing the display panel of claim 6, wherein the light-shielding ink comprises an ultraviolet (UV) curing material.

11. The method for repairing the display panel of claim 10, wherein the UV curing material is cured by UV light, and a wavelength range of the UV light is between 200 nm and 400 nm.

12. The method for repairing the display panel of claim 6, wherein the light-shielding ink comprises an infrared curing material.

13. The method for repairing the display panel of claim 12, wherein the infrared curing material is cured by infrared, and a wavelength range of the infrared is between about 2.6 μm and about 25 μm.

14. A display panel, comprising:
a display medium cell having a defect;
a polarizer disposed on a surface of the display medium cell, wherein an outer surface of the polarizer has a recess corresponding to the defect; and
a light-shielding material disposed in the recess.

15. The display panel of claim 14, wherein the light-shielding material comprises a light-shielding ink.

16. The display panel of claim 15, wherein a material of the light-shielding ink comprises epoxy resin, acrylic resin or styrene-butadiene rubber (SBR).

17. The display panel of claim 15, wherein the light-shielding ink comprises a thermal curing material.

18. The display panel of claim 17, wherein a curing temperature of the thermal curing material is between about 50 degrees centigrade and about 70 degrees centigrade.

19. The display panel of claim 15, wherein the light-shielding ink comprises a UV curing material.

20. The display panel of claim 15, wherein the light-shielding ink comprises an infrared curing material.
